(19) United States
(12) Patent Application Publication
(10) Pub. No.: US 2005/0273024 A1
(43) Pub. Date: Dec. 8, 2005

(54) Bendable vibrator device

(75) Inventor: Simon Siu Man Nan, Ontario (CA)

Correspondence Address: GREENSFELDER HEMKER & GALE PC, SUITE 2000, 10 SOUTH BROADWAY, ST LOUIS, MO, 63102, US

(73) Assignee: Nanma Manufacturing Co., Ltd.

(21) Appl. No.: 10/862,076

(22) Filed: Jun. 4, 2004

(51) Int. Cl. A61H 1/00; A61H 19/00

(52) U.S. Cl. 601/71; 600/38; 601/69; 601/46

(57) ABSTRACT

A bendable vibrator device adapted to engage a harness worn by a user is disclosed. The vibrator device comprises a bendable middle portion interposed between a distal portion having a vibrating head and a rigid proximal portion. The bendable middle portion includes a malleable member surrounded by a flexible cover forming a plurality of ridges that permit the bendable middle portion to be bent and maintain that bent orientation relative to the proximal portion of the vibrating device. In an embodiment, the vibrator device is adapted to engage a suction cup at the proximal end thereof for engaging the vibrator device to the harness, while the distal end is adapted to receive an interchangeable prosthetic aid extension

### FIELD OF THE INVENTION

The present invention relates to a vibrator device, and more particularly to a bendable vibrator device.

### BACKGROUND OF THE INVENTION

Vibrator devices for recreational and therapeutic use are well known in the art. A prior art vibrator device usually comprises a rigid body having a distal portion in communication with a proximal portion. The distal portion may include a vibrating head driven by a vibrating element powered by a battery stored inside the proximal portion of the vibrator device.

Although prior art vibrator devices may be manually manipulated by the user, such rigid devices are incapable of being bent at various orientations relative to the proximal portion of the device. Other prior art vibrator devices may have a flexible distal portion having a vibrating means, however the flexible distal portions of such vibrator devices may be flaccid and incapable of maintaining any type of bent orientation relative to the body of the vibrator device.

In addition, a prior art vibrator device may be engaged to a harness or similar article of clothing, if desired. The engagement of the vibrator device to the harness can be accomplished by a mechanical arrangement, such as a spring loaded mechanism, that requires that the vibrator device be equipped with a compatible structural arrangement that permits a mechanical attachment of the vibrator device to the harness. However, such mechanical arrangements are expensive to manufacture.

Therefore, there is a need in the art for a vibrator device having a bendable middle portion capable of maintaining the distal portion at a bent orientation relative to the proximal portion of the device. There is a further need for a vibrator device adapted to engage an article of clothing in a simple, effective and inexpensive manner.

### OBJECT AND SUMMARY OF THE INVENTION

A primary object of the present invention is to provide a vibrator device having a bendable portion that can be bent relative to the rest of the device.

Another object of the present invention is to provide a vibrator device having a bendable portion that can maintain a bent orientation relative to the rest of the device.

A further object of the present invention is to provide a vibrator device that is adapted to engage an article of clothing, such as a harness.

Yet another object of the present invention is to provide a vibrator device that is adapted to engage an article of clothing using a suction cup.

Another further object of the present invention is to provide a vibrator device that provides a means for conveniently achieving various hand-held wrist orientations of the vibrator device by the user.

Yet another further object of the present invention is to provide a vibrator device capable of being secured to a stationary surface and maintain any bent orientation relative to the stationary surface.

These and other objects of the present invention are realized in the an embodiment of the present invention, described by way of example and not by way of limitation, which provides for a bendable vibrator device comprising a body including a distal portion having a vibrating head in communication with a rigid proximal portion having a bendable middle portion interposed between the distal portion and the proximal portion. In addition, the bendable middle portion is adapted to maintain a bent orientation relative to the proximal portion of the body.

In an embodiment of the present invention, the vibrator device is adapted to engage a suction cup that permits the vibrator device to be engaged to either an article of clothing or a stationary surface while permitting the bendable middle portion to maintain a bent orientation relative to the proximal portion of the device. In another embodiment, the distal portion of the vibrator device is adapted to engage an interchangeable hollow prosthetic aid extension.

### BRIEF DESCRIPTION OF THE DRAWINGS

FIG. 1 is a side view of the bendable vibrator device with a suction cup shown in the detached position according to the present invention;

FIG. 2 is a side view of the bendable vibrator device with the suction cup shown in the attached position according to the present invention;

FIG. 3 is a fragmentary side view of the bendable vibrator device according to the present invention;

FIG. 4 is a side view of the bendable vibrator device shown in a bent orientation according to the present invention;

FIG. 5A is a top view of the suction cup according to the present invention;

FIG. 5B is a bottom view of the suction cup according to the present invention;

FIG. 5C is a side view of the suction cup according to the present invention;

FIG. 6A is a top view of the bendable vibrator device according to the present invention;

FIG. 6B is a bottom view of the bendable vibrator device according to the present invention; and

FIG. 7 is a perspective view of the bendable vibrator device engaged to a harness at one end and a prosthetic aid extension at another end thereof.

### DETAILED DESCRIPTION OF THE INVENTION

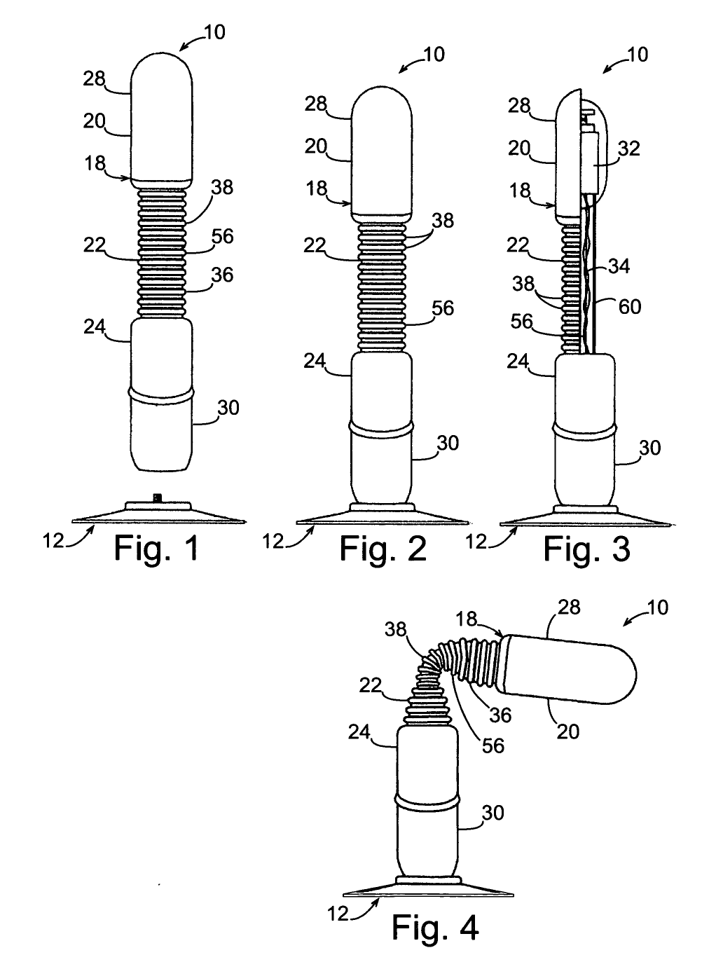

Referring to the drawings, a preferred embodiment of the bendable vibrator device according to the present invention is illustrated and generally indicated as 10 in FIG. 1. The present invention comprises a bendable vibrator device 10 including a body 18 having a bendable middle portion 22 engaged between a distal portion 20 and proximal portion 24.

Referring to FIGS. 1-3 and 6A-B, distal portion 20 includes a vibrating head 28 having a vibration element 32 (FIG. 3) powered by a battery (not shown) through wires 34 encased in body 18. As further shown, proximal portion 24 forms a battery compartment 30 for housing the battery and provide a means for regulating the degree of vibration imparted by the vibrating element 32 to the vibrating head 28. Preferably, proximal portion 24 includes a rotatable regulator 54 (FIG. 6B) that provides a means for regulating the degree of vibration by rotation of the regulator 54 in either a clockwise or counter-clockwise direction in order to increase or decrease the degree of vibration imparted by the vibrating element 32.

As illustrated in FIGS. 3 and 4, the bendable middle portion 22 is capable of maintaining a bent orientation relative to the proximal portion 24. Bendable middle portion 22 includes a flexible cover 56 forming a plurality of ridges 38 that encases a malleable member 60. As further shown, malleable member 60 connects the distal portion 20 to the proximal portion 24 such that the bendable middle portion 22 may be bent relative to the proximal portion 24 and maintain that bent orientation. Preferably, malleable member 60 is a flexible stainless steel wire; however, the present invention contemplates that malleable member 60 may be made from other malleable metals or non-metal materials which are capable of being repeatedly bent at room temperature and maintain that bent orientation.

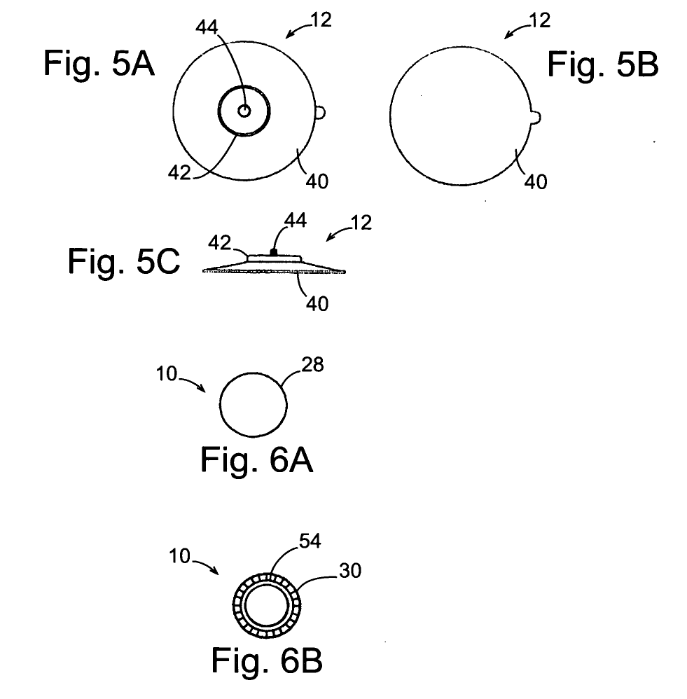

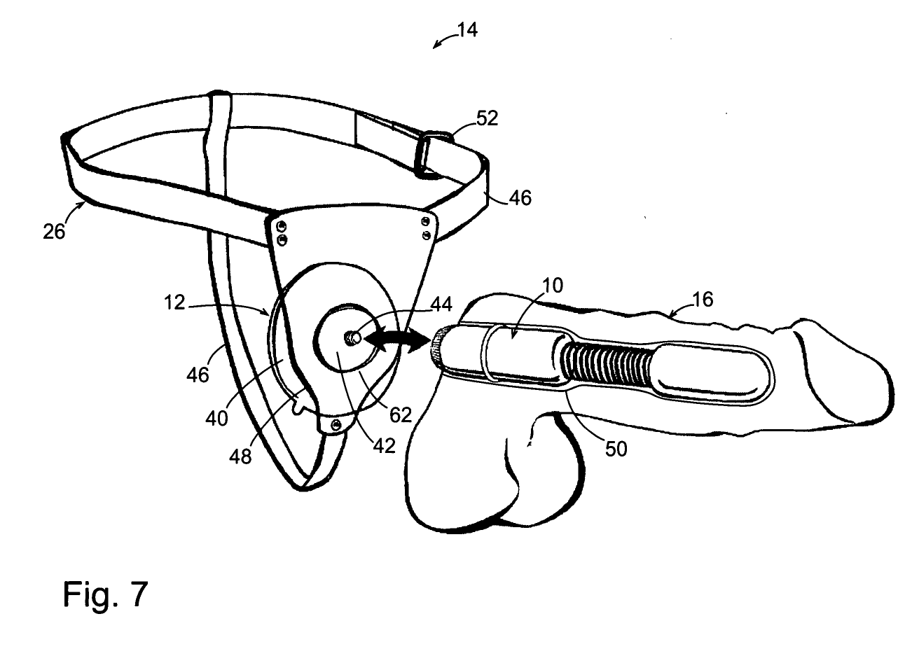

According to an embodiment of the present invention, the vibrator device 10 is adapted to engage a securing means, preferably a suction cup 12, in order to attach the vibrator device 10 to either a stationary surface (not shown) or an article of clothing, such as a harness 14 (FIG. 7). As shown in FIGS. 5A-5C, suction cup 12 comprises a tapered flexible flange 40 that surrounds a central stem 42 having a centrally located screw 44 adapted to engage the proximal portion 24 of vibrator device 10 as shall be discussed in greater detail below. In the alternative, a suitable strapping mechanism that straps the vibrator device 10 to harness 14 may be substituted for the suction cup 12 and faceplate 48 arrangement of the present invention.

Referring to FIG. 7, harness 14 comprises a harness body 26 having a plurality of straps 46 adapted to engage the user's waist and inguinal area. The harness body 26 further includes a faceplate 48 secured to straps 26 with faceplate 48 forming an aperture 62. The faceplate 48 is positioned along the harness body 26 such that the faceplate 48 covers the crotch area of the user when worn by the user. A buckle 52 is provided for adjusting the straps 46 to accommodate the physical size of the user. When engaging the vibrator device 10 to harness 14 the user inserts the stem 42 of the suction cup 12 through the aperture 62 such that the flange 40 abuts the rear portion of the faceplate 48 and the screw 44 is exposed through aperture 62. The user then engages the proximal portion 24 of the vibrator device 10 to the stem 42 by engaging screw 44 to a hole (not shown) formed along the end of proximal portion 24.

The present invention contemplates that the vibrator device 10 is adapted to engage an interchangeable and hollow prosthetic aid extension 16. As shown, the prosthetic aid extension 16 forms an interior cavity 50 adapted to engage the vibrator device 10 when inserting the extension 16 over body 18. In addition, the prosthetic aid extension 16 may assume a realistic phallic shape. Preferably, the user may engage the vibrator device 10 to the harness 12 before engaging the prosthetic aid extension 16 to the vibrator device 10, although the user may also first engage the extension 16 to the vibrator device 10 prior to securing device 10 to harness 14. Once the vibrator device 10 is engaged to the harness 12, the user may remove the prosthetic aid extension 16 and engage a different type of prosthetic aid extension 16 to body 18 without removing the vibrator device from harness 12.

It should be understood from the foregoing that, while particular embodiments of the invention have been illustrated and described, various modifications can be made thereto without departing from the spirit and scope of the invention as will be apparent to those skilled in the art. Such changes and modifications are within the scope and teaching of this invention as defined in the claims appended hereto.

1. A vibrator device comprising:
a body, said body including a distal portion having a vibrating head, said distal portion in communication with a rigid proximal portion having bendable middle portion interposed between said distal portion and said proximal portion, said bendable middle portion adapted to maintain said distal portion at a bent orientation relative to the proximal portion of said body.

2. The vibrator device according to claim 1, further comprising a suction cup, said suction cup adapted to be engaged to said proximal portion of said body.

3. The vibrator device according to claim 2, wherein said suction cup comprises a cup member attached to a flexible flange by a stem member.

4. The vibrator device according to claim 3, wherein said flange is adapted to engage the vibrator device to a harness.

5. The bendable vibrator device according to claim 1, wherein said distal portion is adapted to receive a hollow prosthetic aid extension.

6. The vibrator device according to claim 3, wherein said flange is adapted to engage the vibrator device to a stationary surface.

7. The vibrator device according to claim 4, wherein said harness comprises a face plate, said face plate forming an aperture, wherein said aperture is adapted to engage suction cup for attaching the vibrator device to said harness.

8. The vibrator device according to claim 1, wherein said bendable middle portion includes a malleable member adapted to be bent and maintain a bent orientation.

9. The vibrator device according to claim 8, wherein said malleable member is encased in a flexible cover.

10. A vibrator device adapted to engage a harness worn by a user comprising:
a body, said body comprising a bendable middle portion interposed between a distal portion and a proximal portion, said distal portion having a vibrating head and said bendable middle portion adapted to be bent and maintain that bent orientation relative to said proximal portion,
a suction cup adapted to engage said proximal portion, and
a harness body including at least one strap member configured to be worn by a user, said harness body further including a face plate, said face plate forming an aperture adapted to engage said suction cup such that said vibrator body is secured to said harness body.

11. The vibrator device according to claim 10, wherein said suction cup includes a cup member engaged to a flexible flange by a stem member.

12. The vibrator device according to claim 11, wherein said flexible flange is adapted to engage said suction cup to said face plate through said aperture.

13. A vibrator device in combination with a suction cup comprising:
a body, said body comprising a bendable middle portion engaged between a distal portion and a proximal portion, said distal portion having a vibrating head, said bendable middle portion adapted to be bent and maintain that bent orientation relative to said proximal portion, and
a suction cup adapted to engage said proximal portion, wherein said suction cup permits said body to be engaged to a stationary surface such that said distal portion can maintain a bent orientation relative to said stationary surface.
